(19) United States
(12) Patent Application Publication
(10) Pub. No.: US 2023/0387689 A1
(43) Pub. Date: Nov. 30, 2023

(54) LOCAL CO-OPTIMIZATION OF POWER GENERATION SUPPLY WITH DATA CENTER ENERGY DEMAND

(71) Applicant: Soluna Computing, Inc., New York, NY (US)

(72) Inventors: Phillip Ng, New York, NY (US); John Belizaire, New York, NY (US); Dipul Patel, New York, NY (US); Mohamed Larbi Loudiyi, New York, NY (US)

(21) Appl. No.: 18/116,275

(22) Filed: Mar. 1, 2023

Related U.S. Application Data
(60) Provisional application No. 63/315,145, filed on Mar. 1, 2022.

(51) Int. Cl. H02J 3/14; H02J 3/38

(52) U.S. Cl. CPC H02J 3/14; H02J 3/381; H02J 2203/10; H02J 2310/16

(57) ABSTRACT

A data center has a distribution network and a control system. The control system receives substation meter data, distributed energy resource (DER) meter data, and receive data center meter data. The control system selects a data center operating mode using the substation meter data, the DER meter data, and the data center meter data. The control system then adjusts power consumption of the distribution network based on the selected the data center operating mode.

### PRIORITY

This patent application claims priority from provisional U.S. patent application No. 63/315,145, filed Mar. 1, 2022, and entitled, “LOCAL CO-OPTIMIZATION OF POWER GENERATION SUPPLY WITH DATA CENTER ENERGY DEMAND,” the disclosure of which is incorporated herein, in its entirety, by reference.

### FIELD

Illustrative embodiments of the invention generally relate to power management and, more particularly, various embodiments of the invention relate to power management relating to data centers.

### BACKGROUND

Data centers may be buildings or groups of buildings that house computing systems and associated components. Data centers support a variety of business applications and activities, including email and file sharing, artificial intelligence, machine learning, and communications services, among other things. These activities are enabled through the infrastructure for network connectivity, central processing, and data storage within the data center.

Some data centers allow customers to submit computing tasks which are then scheduled to be performed by a data center. The availability of a data center may be dependent on a number of factors including real-time cost, such as the cost to provide power to the data center.

### SUMMARY OF VARIOUS EMBODIMENTS

In accordance with one embodiment of the invention, a data center has a distribution network and a control system. The control system receives substation meter data, distributed energy resource (DER) meter data, and receive data center meter data. The control system then selects a data center operating mode using the substation meter data, the DER meter data, and the data center meter data. The control system then adjusts power consumption of the distribution network based on the selected the data center operating mode.

In some embodiments, the control system receives the substation meter data from a central control system, receives the DER meter data from a DER meter measures power generation of a DER, and receives the data center meter data from a data center meter measures the power consumption of the data center. The substation meter data may be generated by a substation meter measures power conducted by a substation.

A DER corresponding to the DER meter data, the data center, and a substation corresponding to the substation meter data may be coupled by way of a substation distribution network.

In some embodiments, the control system determines a central control system has transmitted a generation curtailment request to a DER corresponding to the DER meter data. In response, the control system may increase the power consumption of the distribution network.

In some embodiments, the control system determines an operating cost threshold and selects a second operating mode in response to determining the operating cost threshold.

The control system may adjust the power consumption of the data center by toggling loads of the distribution network.

In accordance with another embodiment of the invention, a data center control system has a data acquisition circuit to receive substation meter data, distributed energy resource (DER) meter data, and receive data center meter data. The data center control system also has a mode selection circuit configured to select a data center operating mode using the substation meter data, the DER meter data, and the data center meter data. The data center also has a response circuit to adjust power consumption of a data center distribution network based on the selected the data center operating mode.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a power network in accordance with various embodiments.

FIG. 2 schematically shows a communication network for a data center control system in accordance with various embodiments.

FIG. 3 schematically shows a computing device in accordance with various embodiments.

FIG. 4 is a flowchart showing a process for providing power to a data center in accordance with various embodiments.

### DESCRIPTION OF ILLUSTRATIVE EMBODIMENTS

In illustrative embodiments, a data center is in a substation distribution network with a distributed energy resource (DER). Each of the substation, the data center, and the DER have an associated meter that measures power. Using the meter measurements, the data center control system selects operational modes for the data center. The operational modes, among other things, minimize the cost of powering the data center. Details of illustrative embodiments are discussed below.

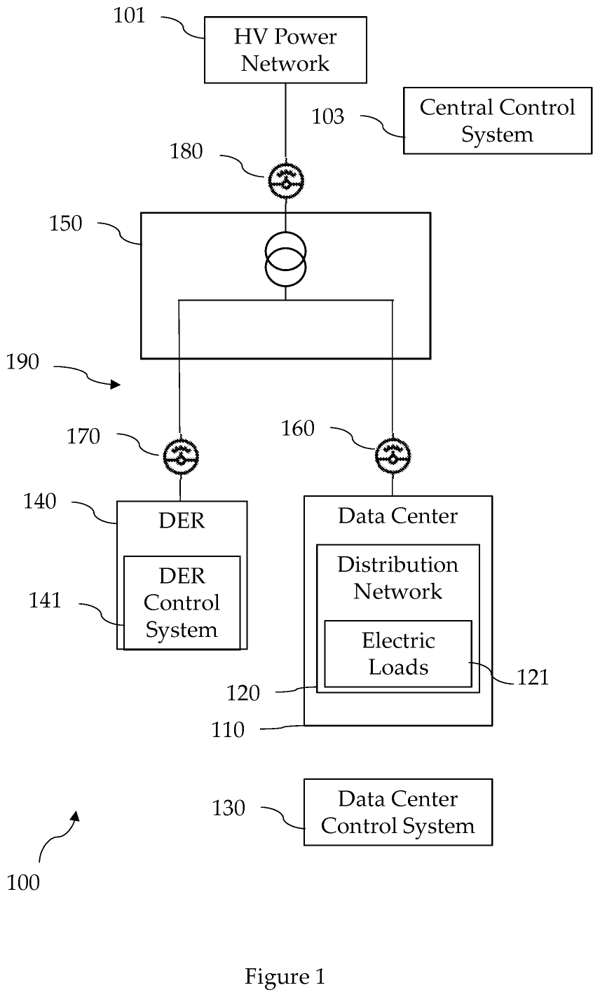

FIG. 1 schematically shows a power network 100 configured to generate and provide power to electrical loads. In the illustrated embodiment, the power network 100 is a utility grid. In other embodiments, the power network 100 may be a microgrid or a vehicular power system, among other things. The power network 100 may transmit alternating current (AC) power or direct current (DC) power. The power network 100 may transmit single phase or multi-phase power, among other things.

The power network 100 may be monitored or controlled by a central control system 103. In some embodiments, the central control system 103 may be a system operator, among other things. In some embodiments, the central control system 103 aggregates power characteristic data and other data which may be accessible by other control systems in the power network 100. For example, the central control system 103 may receive weather data or meter data which may be transmitted to another power network control system.

The power network 100 has a substation 150 configured to adjust the voltage of power exchanged between a high-voltage section of the power network 100 and a low-voltage section of the power network 100. The substation 150 is coupled to a high-voltage (HV) power network 101. The power network 100 has a substation meter 180 which monitors the power exchanged between the substation 150 and the HV power network 101. Among other things, the substation meter 180 may include sensors or other measuring devices configured to generate substation meter data by measuring voltage, current, or reactive power, among other things. The substation meter 180 may be a single device measuring multiple phases, or a plurality of devices each measuring a single phase, among other things.

When the substation 150 conducts power from the HV power network 101 to the low-voltage section of the power network 100, also known as the substation distribution network 190, the substation 150 steps down the voltage of the power using a transformer, among other things. When the substation 150 conducts power from the substation distribution network 190 to the HV power network 101, the substation steps up the voltage of the power using the transformer.

The power network 100 has a distributed energy resource (DER) 140 configured to generate power. The DER 140 is coupled to the substation distribution network 190 such that power from the DER 140 may be provided to the data center 110 without flowing through the substation meter 180. In some embodiments, the DER 140 also consumes or stores power from the substation distribution network 190.

The DER 140 may have any power source configured to provide power, though preferably the power source is a renewable energy source. For example, the DER 140 may include a solar panel, a solar array, a wind turbine, a battery bank, a capacitor bank, a hydro-electric turbine, a natural gas generator, or a diesel generator, among other things. The DER 140 may have power electronics to convert power generated by the power source of the DER 140 to power providable to the substation distribution network 190.

The DER 140 has a DER control system 141 to control the output of power from the DER 140 and monitor the DER 140. The DER control system 141 may provide data to other computing devices, such as power characteristics of the DER 140 or the real-time or forecasted cost of consuming the power provided by the DER 140.

The power network 100 has a DER meter 170 which monitors the power exchanged between the DER 140 and the substation distribution network 190. Among other things, the DER meter 170 may include sensors or other measuring devices configured to generate DER meter data by measuring voltage, current, or reactive power, among other things. The DER meter 170 may be a single device measuring multiple phases, or a plurality of devices each measuring a single phase, among other things.

The power network 100 includes a data center 110 configured to receive power and perform computing tasks. The data center 110 has electrical loads 121 which consume power provided by the power network 100. The electrical loads 121 may include, among other things, a computing array having a plurality of computing devices configured to receive computing task assignments and perform the computing tasks. To perform the computing tasks, the computing devices of the computing array require power. The data center 110 includes a distribution network 120 which selectively distributes power to the electrical loads 121 to turn on or off a portion or entirety of the electrical loads 121.

The power network 100 has a DER meter 170 which monitors the power exchanged between the DER 140 and the substation distribution network 190. Among other things, the DER meter 170 may include sensors or other measuring devices configured to generate DER meter data by measuring voltage, current, or reactive power, among other things. The DER meter 170 may be a single device measuring multiple phases, or a plurality of devices each measuring a single phase, among other things.

The power network 100 has a data center control system 130 configured to operate the distribution network 120 to selectively power the electrical loads 121. The data center control system 130 operates the data center distribution network 120 to selectively provide power to the electrical loads 121 based on data generated by the substation meter 180, the DER meter 170, and the data center meter 160, among other things. The data center control system 130 may also operate the data center distribution network 120 to selectively provide power to the electrical loads 121 based on data provided by other control systems of the power network or external data sources, among other things.

The data provided by the other control systems may include a cost of purchasing power from a power source, also known as a price signal, which may represent a real-time cost or a forecasted cost for purchasing power at a later time. In the illustrated embodiment, the data center 110 may purchase power from either the DER 140 or the HV power network 101. The cost of purchasing power from either power source, also known as the DER cost or HV cost, may be simultaneously different.

Using data received by the data center control system 130, the distribution network 120 provides power to the electrical loads 121 according to a selected operational modes. The operation mode may be selected by the data center control system 130 for an instant, or for a time window, among other things.

In some embodiments, the data center control system 130 includes a remote device which operates the data center distribution network 120 remotely. In some embodiments, the data center control system 130 is a distributed or federated group of controllers, each controller being associated with one or more of the electrical loads 121.

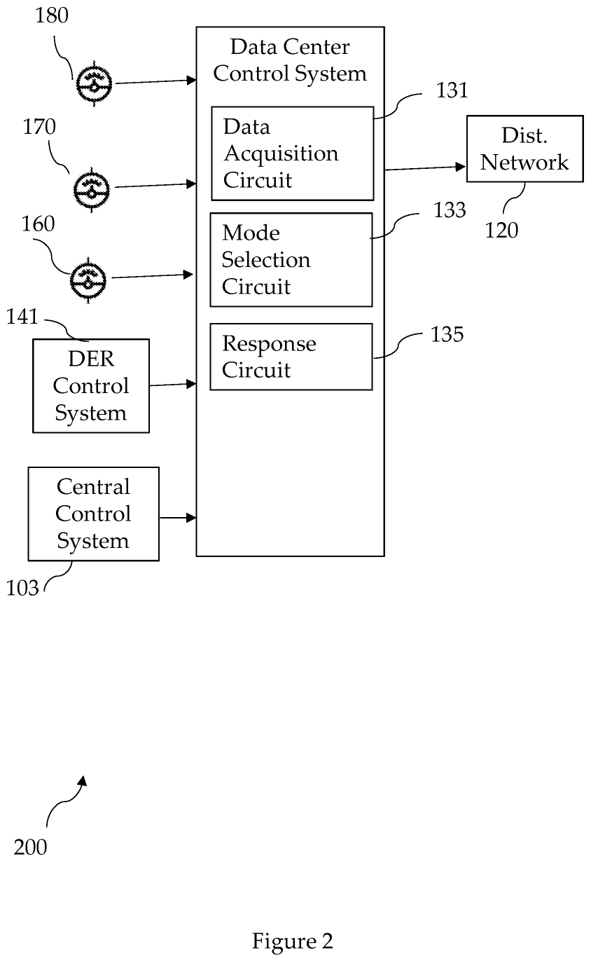

FIG. 2 schematically shows components configured to communicate with the data center control system 130 (collectively the data center communication network 200).

The data center control system 130 has a data acquisition circuit 131 configured to communicate with other devices of the power network 100. In the illustrated embodiment, the data acquisition circuit 131 communicates with the substation meter 180, the DER meter 170, and the data center meter 160. The data acquisition circuit 131 may communicate with the meters of the power network 100 directly or by way of a control system, among other things. For example, the data acquisition circuit 131 may receive data directly from the DER meter 170 and the data center meter 160 while receiving data generated by the substation meter 180 by way of the central control system 103.

The substation meter 180 may provide data including power characteristics of the power on the high-voltage side of the substation 150, among other things. The power characteristics may include voltage, current, or reactive power, among other things. The power characteristics may include the direction of the flow of power. The power characteristics may be real-time measurements, historical measurements, or measurement trends, among other things.

The DER meter 170 may provide data including power characteristics of the power at the connection between the DER 140 and the substation distribution network 190. The power characteristics may include voltage, current, or reactive power, among other things. The power characteristics may indicate the direction of the flow of power. The power characteristics may be real-time measurements, historical measurements, or measurement trends, among other things.

The data center meter 160 may provide data including power characteristics of the power at the connection between the data center 110 and the substation distribution network 190. The power characteristics may include voltage, current, or reactive power, among other things. The power characteristics may indicate the direction of the flow of power. The power characteristics may be real-time measurements, historical measurements, or measurement trends, among other things.

The DER control system 141 may provide to the data center control system 130 data from the DER meter 170, as well as other data, such as weather data configured to indicate current weather or forecasted weather in the area of the DER 140, irradiance data configured to indicate current irradiance or forecasted irradiance in the area of the DER 140, wind speed data configured to indicate current wind speed or forecasted wind speed in the area of the DER 140, generation curtailment requests indicated the DER 140 has received a request to reduce power generation due to excessive power supply within the power network 100, and DER cost data including the current or forecasted cost of purchasing power from the DER 140, among other things.

The central control system 103 may provide to the data center control system 130 data from the substation meter 180, as well as other data, such as weather data, irradiance data, load curtailment requests, ancillary service requests, generation curtailment requests, and HV cost data including the current or forecasted cost of purchasing power from the HV power network 101.

The data acquisition circuit 131 may receive additional data from the illustrated sources or other data sources. For example, the data acquisition circuit 131 may receive an operational cost threshold, which indicates the maximum cost at which the data center 110 should purchase power from either the DER 140 or the HV power network 101. The operational cost threshold may also be determined by the data center control system 180 as a function of price of the computing services performed by the computing array of the data center 110. In another example, the data acquisition circuit 131 may receive data from multiple DERs instead of just the DER 140. In still another example, the data acquisition circuit 131 may receive data corresponding to natural disasters or data center fleet availability affecting the supply of computing devices to perform the computing tasks assigned to the data center 110.

The data center control system 130 has a mode selection circuit 133 configured to select one of many operating modes for the data center 110 based on the data received by the data acquisition circuit 131.

For a standby mode selection, where the data center 110 will power down due to a lack of cost effective power, the mode selection circuit 133 may use the DER cost data, the HV cost data, the DER meter data, and the operating cost threshold. The circuit 133 selects standby mode if the cost of power from the DER 140 and the cost of power from the HV power network 101 exceeds the operational cost threshold, or if there is insufficient power available from the DER 140 and the HV power network 101.

For an HV only mode selection, where the data center 110 receives power purchased only from the HV power network 101, the mode selection circuit 133 may use the DER cost data, the HV cost data, the DER meter data, and the operating cost threshold. The circuit 133 selects HV only mode if the cost of power from the HV power network 101 is less than the cost of the operating cost threshold, and the cost of power from the DER 140 is greater than the operating cost threshold or power from DER 140 is not available.

For a DER only mode selection, where the data center 110 receives power only from the DER 140, the mode selection circuit 133 may use the DER cost data, the HV cost data, the DER meter data or DER capacity data, and the operating cost threshold. The DER capacity data may be received from the DER control system 141 or determined. For example, for a wind turbine, capacity may be determined based on wind speed data. The circuit 133 may select DER only mode if the cost of power from the DER 140 is less than the operating cost threshold and the cost of power from the HV power network 101 is greater than operating cost threshold or HV power network 101 is not available (e.g., microgrid mode).

For an excess DER generation mode selection, where the DER is generating more power than the data center is currently purchasing, the mode selection circuit may use DER meter data, substation meter data, data center meter data, and DER cost data. The circuit 133 may select excess DER generation mode if 1) the substation meter data indicates power is being exported to the HV power network 101 and 2) the data center meter data and DER meter data indicates the data center 110 is using less than all power output by the DER 140.

For a hybrid source mode selection, where the DER and HV power network 101 provide power to the data center 110, the mode selection circuit 133 may use DER cost data, HV cost data, DER meter data and operating cost threshold. The circuit 133 may select hybrid source mode if the DER cost and HV cost is less than the operating cost threshold and the DER meter data indicates DER power output is less than a data center 110 power demand.

For an ancillary service mode selection, where the power network 101 has detected abnormalities within the HV power network 101, the mode selection circuit 133 may select the ancillary service mode after receiving a request to provide ancillary service.

For a generation curtailment mode selection, where the central control system 103 has requested the DER 140 reduce power output, the mode selection circuit 133 may determine the DER 140 received a request to reduce power output.

The data used to select the operating mode may be the data received by the data center control system 130, or a derivative thereof determined by the data center control system 130. For example, the data center control system 130 may determine the monthly power consumption of the data center has triggered a price increase and in response, the DER cost or HV cost may be adjusted to reflect the additional charge for continuing to use power for the remainder of the month. A similar example would include adjusting the costs based on participation in the 4 Coincident Peak (4CP) program.

The data center control system has a response circuit 135 configured to purchase power and operate the data center distribution network 120 according to the selected operating mode. The response circuit 135 may operate the network 120 according to a schedule, for a time window, or until the response circuit 135 receives an updated operating mode from the mode selection circuit 133.

In the standby mode, the response circuit 135 operates the network 120 to not provide power to the electrical loads 121, thereby powering down the data center 110.

In HV only mode, the response circuit 135 purchases power from the HV power network 101 and operates the network 120 to provide the power to the electrical loads 121.

In DER only mode, the response circuit 135 purchases an amount of power from the DER 140 and operates the network 120 to provide the power to the electrical loads 121. The amount of power is based on the capacity of the DER 140.

In excess DER generation mode, the response circuit 135 purchases an amount of additional power from the DER 140 and operates the network 120 to provide the additional power to the electrical loads 121. The amount of the additional power may be the lesser of the excess power exported to HV power network 101 and the difference between the data center power consumption and the DER 140 power output.

In hybrid source mode, the response circuit 135 purchases the available power from the DER 140 and the remaining power required by the data center 110 from the HV power network 101. The response circuit 135 operates the network 120 to provide power to the electrical loads 121.

In ancillary service mode, the response circuit 135 operates the distribution network to respond to the determined abnormalities in the power network with ancillary services. Ancillary services may include helping the system recover from unplanned contingencies by reducing load on-demand from the central control system 103. Ancillary services may also include helping to maintain the power of the power network 100 at a required frequency by increasing or decreasing power consumption on timescales of 1 to 4 seconds per cycle.

In generation curtailment mode, the response circuit 135 purchases the power that was requested to be curtailed from the DER 140, and operates the distribution network 120 to provide the power to the electrical loads 121.

In some embodiments, the response circuit 135 validates the selected operational mode using data received by the data acquisition circuit 131, such as the meter data. For example, the response circuit 135 may use the substation meter data generated by the substation meter 180 to confirm excess power is being transferred to the HV power network 101 and thus validate the selection of excess power generation mode. In another example, the response circuit 135 may invalidate a selected excess DER generation mode in response to determining the DER 140 received a request to curtail generation and should thus be in generation curtailment mode.

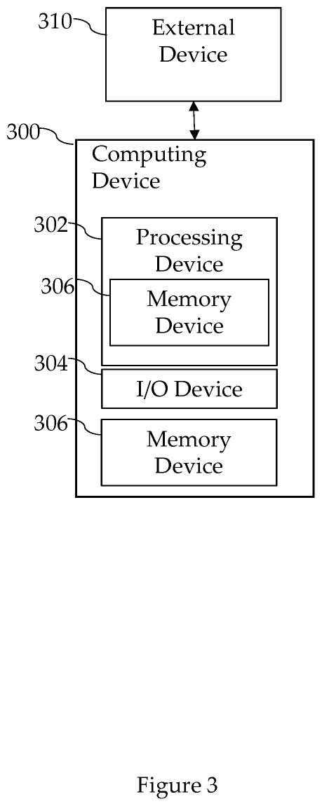

FIG. 3 schematically shows a computing device 300 in accordance with various embodiments. The computing device 300 is one example of a computing device which is used in the power network 100 in FIG. 1, such as central control system 103, data center control system 130, DER control system 141, data center meter 160, DER meter 170, substation meter 180, data acquisition circuit 131, mode selection circuit 133, or response circuit 135, among other things. The computing device 300 includes a processing device 302, an input/output device 304, and a memory device 306. The computing device 300 may be a stand-alone device, an embedded system, or a plurality of devices configured to perform the functions described with respect to one of the components of power network 100. Furthermore, the computing device 300 may communicate with one or more external devices 310.

The input/output device 304 enables the computing device 300 to communicate with an external device 310. For example, the input/output device 304 in different embodiments may be a network adapter, network credential, interface, or a port (e.g., a USB port, serial port, parallel port, an analog port, a digital port, VGA, DVI, HDMI, FireWire, CAT 5, Ethernet, fiber, or any other type of port or interface), among other things. The input/output device 304 may be comprised of hardware, software, and/or firmware. It is contemplated that the input/output device 304 has more than one of these adapters, credentials, or ports, such as a first port for receiving data and a second port for transmitting data.

The external device 310 may be any type of device that allows data to be input or output from the computing device 300. For example, external device 310 in different embodiments is a meter, a control system, a sensor, a mobile device, a reader device, equipment, a handheld computer, a diagnostic tool, a controller, a computer, a server, a printer, a display, a visual indicator, a keyboard, a mouse, a touch screen display, among other things. Furthermore, the external device 310 may be integrated into the computing device 300. More than one external device may be in communication with the computing device 300.

The processing device 302 may be a programmable type, a dedicated, hardwired state machine, or a combination of these. The processing device 302 may further include multiple processors, Arithmetic-Logic Units (ALUs), Central Processing Units (CPUs), Digital Signal Processors (DSPs), Field-programmable Gate Array (FPGA), among other things. For forms of the processing device 302 with multiple processing units, distributed, pipelined, or parallel processing may be used. The processing device 302 may be dedicated to performance of just the operations described herein or may be used in one or more additional applications. The processing device 302 may be of a programmable variety that executes processes and processes data in accordance with programming instructions (such as software or firmware) stored in the memory device 306. Alternatively or additionally, programming instructions are at least partially defined by hardwired logic or other hardware. The processing device 302 may be comprised of one or more components of any type suitable to process the signals received from the input/output device 304 or elsewhere, and provide desired output signals. Such components may include digital circuitry, analog circuitry, or a combination of both.

The memory device 306 in different embodiments may be of one or more types, such as a solid-state variety, electromagnetic variety, optical variety, or a combination of these forms, to name but a few examples. Furthermore, the memory device 306 may be volatile, nonvolatile, transitory, non-transitory or a combination of these types, and some or all of the memory device 306 may be of a portable variety, such as a disk, tape, memory stick, or cartridge, to name but a few examples. In addition, the memory device 306 may store data that is manipulated by the processing device 302, such as data representative of signals received from or sent to the input/output device 304 in addition to or in lieu of storing programming instructions, among other things. As shown in FIG. 3, the memory device 306 may be included with the processing device 302 or coupled to the processing device 302, but need not be included with both.

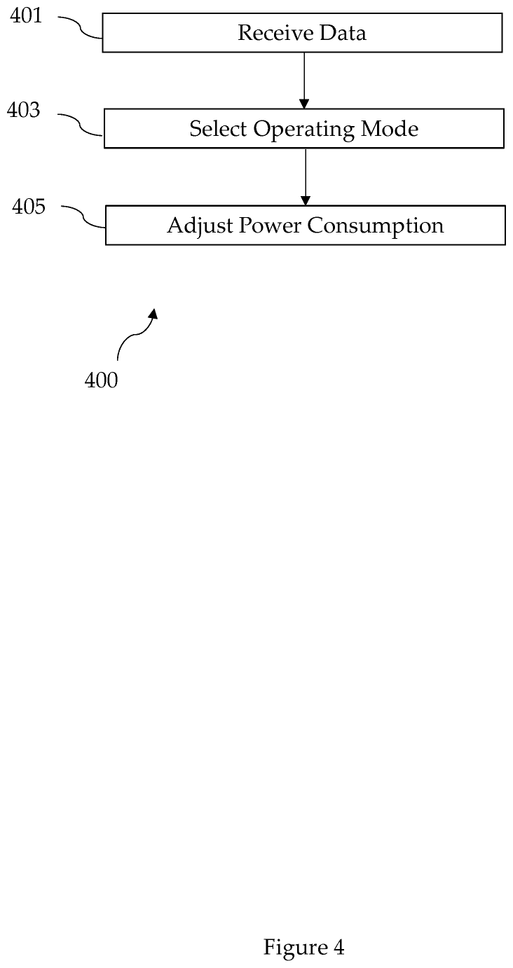

FIG. 4 shows an exemplary process 400 for providing power to a data center in accordance with various embodiments. Process 400 may be implemented in whole or in part in the data center control system 130 disclosed herein. In certain forms the functionalities may be performed by separate devices of the data center control system, such as distributed controllers associated with the electrical loads 121. In certain forms all functionalities may be performed by the same device. It shall be further appreciated that a number of variations and modifications to Process 400 is contemplated including, for example, the omission of one or more aspects of Process 400, the addition of further conditionals and operations, or the reorganization or separation of operations and conditionals into separate processes.

Process 400 begins at operation 401 where the data acquisition circuit 131 receives data or other information that may be used to operate the data center 110. The data may include substation meter data, distributed energy resource (DER) meter data, and data center meter data, as well as DER cost data, HV network cost data, the operational cost threshold, ancillary requests, generation curtailment requests, weather data, irradiance data, wind speed data, or water level data, among other things.

After the data acquisition circuit 131 acquires the data needed to evaluate the operating mode of the data center, Process 400 proceeds to operation 403 where the mode selection circuit 133 selects one of many operating modes for the data center 110 by evaluating the acquired data. Among other data, the mode selection circuit 133 selects an operating mode using the substation meter data, the DER meter data, and the data center meter data.

In some embodiments, the mode selection circuit 133 selects the generation curtailment mode after the DER 140 receives a request to reduce power generation. Operating in the generation curtailment mode may cause the data center 110 to consume some or all of the excess power generated by the DER 140.

In some embodiments, the mode selection circuit 133 may select a new operating mode after receiving an updated operating cost threshold. For example, the demand and price for computing services may increase causing the operating cost threshold to increase.

After the mode selection circuit 133 selects the operating mode, the response circuit 135 may adjust the power consumption of the distribution network 120 based on the operating mode. For example, if the selected operating mode differs from a previous operating mode, the response circuit 135 may activate or deactivate electrical loads 121 by selectively providing power to the electrical loads 121 using the distribution network 120. In some embodiments, the distribution network 120 either turns on all electrical loads 121 or turns off all electrical loads 121 in response to the operating mode. In other embodiments, the distribution network 120 turns on a percentage of the electrical loads based on the operating mode, among other things.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

While the present disclosure has been illustrated and described in detail in the drawings and foregoing description, the same is to be considered as illustrative and not restrictive in character, it being understood that only certain exemplary embodiments have been shown and described, and that all changes and modifications that come within the spirit of the present disclosure are desired to be protected. It should be understood that while the use of words such as “preferable,” “preferably,” “preferred” or “more preferred” utilized in the description above indicate that the feature so described may be more desirable, it nonetheless may not be necessary, and embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. The term “of” may connote an association with, or a connection to, another item, as well as a belonging to, or a connection with, the other item as informed by the context in which it is used. The terms “coupled to,” “coupled with” and the like include indirect connection and coupling, and further include but do not require a direct coupling or connection unless expressly indicated to the contrary. When the language “at least a portion” or “a portion” is used, the item can include a portion or the entire item unless specifically stated to the contrary. Unless stated explicitly to the contrary, the terms “or” and “and/or” in a list of two or more list items may connote an individual list item, or a combination of list items. Unless stated explicitly to the contrary, the transitional term “having” is open-ended terminology, bearing the same meaning as the transitional term “comprising.”

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. Such variations and modifications are intended to be within the scope of the present invention as defined by any of the appended claims. It shall nevertheless be understood that no limitation of the scope of the present disclosure is hereby created, and that the present disclosure includes and protects such alterations, modifications, and further applications of the exemplary embodiments as would occur to one skilled in the art with the benefit of the present disclosure.

What is claimed is:

1. A data center, comprising:
a distribution network; and
a control system configured to:
receive substation meter data, distributed energy resource (DER) meter data, and data center meter data,
select a data center operating mode using the substation meter data, the DER meter data, and the data center meter data, and
adjust power consumption of the distribution network based on the selected the data center operating mode.

2. The data center of claim 1, wherein the control system receives the substation meter data from a central control system, receives the DER meter data from a DER meter configured to measure power generation of a DER, and receives the data center meter data from a data center meter configured to measure the power consumption of the data center.

3. The data center of claim 2, wherein the substation meter data is generated by a substation meter configured to measure power conducted by a substation.

4. The data center of claim 1, wherein a DER corresponding to the DER meter data, the data center, and a substation corresponding to the substation meter data are coupled by way of a substation distribution network.

5. The data center of claim 1, wherein the control system is configured to determine a central control system has transmitted a generation curtailment request to a DER corresponding to the DER meter data, and increase the power consumption of the distribution network in response to the generation curtailment request.

6. The data center of claim 1, wherein the control system is configured to determine an operating cost threshold and select a second operating mode in response to determining the operating cost threshold.

7. The data center of claim 1, wherein the control system adjusts the power consumption of the data center by toggling loads of the distribution network.

8. A data center control system for a data center, comprising:
a data acquisition circuit configured to receive substation meter data, distributed energy resource (DER) meter data, and data center meter data;
a mode selection circuit configured to select a data center operating mode using the substation meter data, the DER meter data, and the data center meter data; and
a response circuit configured to adjust power consumption of a data center distribution network based on the selected the data center operating mode.

9. The data center control system of claim 8, wherein the data acquisition circuit receives the substation meter data from a central control system, receives the DER meter data from a DER meter configured to measure power generation of a DER, and receives the data center meter data from a data center meter configured to measure the power consumption of the data center.

10. The data center control system of claim 9, wherein the substation meter data is generated by a substation meter configured to measure power conducted by a substation.

11. The data center control system of claim 8, wherein a DER corresponding to the DER meter data, the data center, and a substation corresponding to the substation meter data are coupled by way of a substation distribution network.

12. The data center control system of claim 8, wherein the data center control system is configured to determine a central control system has transmitted a generation curtailment request to a DER corresponding to the DER meter data, and increase the power consumption of the data center distribution network in response to the generation curtailment request.

13. The data center control system of claim 8, wherein the mode selection circuit is configured to determine an operating cost threshold and select a second operating mode in response to determining the operating cost threshold.

14. The data center control system of claim 8, wherein the response circuit adjusts the power consumption of the data center by toggling loads of the data center distribution network.

15. A computer program product for use on a computer system for providing power to a data center, the computer program product comprising a tangible, non-transient computer usable medium having computer readable program code thereon, the computer readable program code comprising:
program code for receiving substation meter data, distributed energy resource (DER) meter data, and data center meter data;
program code for selecting a data center operating mode using the substation meter data, the DER meter data, and the data center meter data; and
program code for adjusting power consumption of a distribution network of the data center based on the selected the data center operating mode.

16. The computer program product of claim 15, wherein the substation meter data is transmitted from a central control system, the DER meter data is transmitted from a DER meter configured to measure power generation of a DER, and the data center meter data is transmitted from a data center meter configured to measure the power consumption of the data center.

17. The computer program product of claim 15, wherein a DER corresponding to the DER meter data, the data center, and a substation corresponding to the substation meter data are coupled by way of a substation distribution network.

18. The computer program product of claim 15, comprising program code for determining a central control system has transmitted a generation curtailment request to a DER corresponding to the DER meter data, and increasing the power consumption of the distribution network in response to the generation curtailment request.

19. The computer program product of claim 15, comprising program code for determining an operating cost threshold and select a second operating mode in response to determining the operating cost threshold.

20. The computer program product of claim 15, wherein adjusting the power consumption of the data center includes toggling loads of the distribution network.
